(19) United States
(12) Patent Application Publication
(10) Pub. No.: US 2025/0181563 A1
(43) Pub. Date: Jun. 5, 2025

(54) SCALABLE DATA STRUCTURE FOR BINARY FILE DEDUPLICATION

(71) Applicant: Xetdata Inc., Seattle, WA (US)

(72) Inventors: Yucheng Low, Seattle, WA (US); Hoyt Koepke, Seattle, WA (US); Di Xiao, Seattle, WA (US)

(21) Appl. No.: 18/526,379

(22) Filed: Dec. 1, 2023

(51) Int. Cl. G06F 16/22; G06F 16/215

(52) U.S. Cl. CPC G06F 16/2246; G06F 16/215; G06F 16/2255

(57) ABSTRACT

A system may deduplicate a content addressed storage (CAS) tree for a data object. The system may generate a CAS node, including a first hash for a first chunk of the data object and a second hash for a second chunk. A CAS node index may associate the CAS node with the first and second hash. The system may generate an on-disk storage identifier (e.g., file identifier) that corresponds to the generated CAS node and a byte range within the data object. The on-disk storage identifier may be sufficient to identify the data object in a file system. The system may store, on disk-based storage, the generated CAS node relationally to the CAS node index and the on-disk storage identifier. To perform CAS tree deduplication, the system may evaluate subsequently received chunks of the data object, forgo the aforementioned operations for existing chunks, and perform the operations for new chunks.

### SUMMARY

A system for providing versioning of large data objects may seek to minimize storage and network utilization. For example, the system should not need to upload an entire object to create a new version of the object, and each version of the object should not require an entire new copy to be stored. Ideally only a small description of the set of changes (e.g., a delta) may be used to represent a new version. This is known as the data deduplication problem.

Existing systems fail to adequately address the deduplication problem for a variety of reasons. For example, existing systems may be unable to compute differences between data objects efficiently without complete access to the original source data object, may fail to provide flexibility between large and small data chunks that would allow more efficient storage and management of data, may be unable to handle insertions and deletions in the middle of data objects efficiently, and may fail to minimize the transmission costs of renaming, reorganizing, and moving data objects (e.g., small data objects) without incurring large transmission costs.

To address these issues, systems and methods described herein make use of scalable data structures for binary file deduplication. Example scalable data structures described herein can use content-defined trees, which assist with indexing (cross-referencing) and storing data. A content-defined tree may be a tree of cryptographic hashes where each leaf is a hash of a chunk (e.g., data chunk) of a data object, and each parent node (e.g., interior node) is the hash of a concatenation of the hashes of its children nodes. To create parent nodes for the leaf nodes, a computing system may group leaf nodes together based on a rolling hash (e.g., a rolling hash of the hashes of the leaf nodes) satisfying a condition. Each parent node may include a hash that represents the concatenation of the hashes of the leaf nodes that fall under the corresponding parent node.

In some aspects, to generate a content-defined tree, a computing system may obtain a data object comprising a string of bytes. The computing system may divide the string of bytes into a set of chunks, each chunk in the set of chunks having a boundary, wherein each boundary is determined based on a first rolling hash satisfying a first condition and each boundary defines a size of a corresponding chunk. The computing system may generate a content-defined tree by: generating a set of hashes comprising a cryptographic hash for each chunk of the set of chunks, wherein the set of hashes form a first tier of the content-defined tree; generating a set of parent nodes by grouping each hash of the set of hashes based on a second rolling hash satisfying a second condition, and by hashing a concatenation of each resulting group of hashes, wherein the set of parent nodes form a second tier of the content-defined tree; and generating a root node by merging each node in the set of parent nodes. The computing system may store a portion of the content-defined tree in a database.

Generation or use of content-defined trees leads to a novel technical problem in that there should be an effective way to use the content-defined tree in one or more databases to enable stored data to be indexed, deduplicated, and retrieved to recreate data objects (e.g., after the data object is requested from a user device). Existing systems provide no solution for how a content-defined tree may be used effectively for data storage, deduplication, and retrieval.

To address these issues, systems and methods described herein may store at least some items associated with content-defined trees on disk and may process only the relevant portions of content-defined trees in memory. Accordingly, disclosed herein are scalable data structures which enable scaling of content-defined trees beyond the memory of a particular physical or virtual machine. The scalable data structures are on-disk data structures that store data in an indexed manner that enables a computing system to reduce the number of in-memory operations. The number of in-memory operations may be reduced, for example, by using scalable data structures to identify a particular set of items sufficient to perform a requested data operation on a previously created data object (e.g., update a data object, delete a data object, retrieve and reconstruct a data object). Accordingly, the computing system can load into memory, from disk storage, the identified items rather than the entire content-defined storage structure.

Furthermore, the scalable data structures may include lookup indexes, which offer additional technical advantages. For example, one mode of index optimization can include ordering values in the indexes alphabetically, numerically, in a last-in-first-out (LIFO) manner, in a first-in-last-out (FIFO) manner, or in another fashion selected according to the need to optimize updates (e.g., alphabetic or numerical ordering), retrieval (e.g., LIFO ordering) or versioning (e.g., FIFO ordering) of data. Another mode of optimization can include truncating various hash values stored in the indexes (chunk hashes, content-addressed storage hashes, file hashes) to minimize the size of the indexes stored on disk.

In operation, a particular system may deduplicate a content addressed storage (CAS) tree for a data object. The system may generate a CAS node, including a first hash for a first chunk of the data object and a second hash for a second chunk. A CAS node index may associate the CAS node with the first and second hash. The system may generate an on-disk storage identifier (e.g., file identifier) that corresponds to the generated CAS node and a byte range within the data object. The on-disk storage identifier may be sufficient to identify the data object in a file system. The system may store, on disk-based storage, the generated CAS node relationally to the CAS node index and the on-disk storage identifier. To perform CAS tree deduplication, the system may evaluate subsequently received chunks of the data object, forgo the aforementioned operations for existing chunks, and perform the operations for new chunks.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

Implementation variants of the invention can incorporate those of U.S. patent application Ser. No. 17/980,531, which is incorporated herein in its entirety and for all purposes.

### BRIEF DESCRIPTION OF THE DRAWINGS

FIG. 1 shows an illustrative diagram for generating and using content-defined trees, in accordance with one or more embodiments.

FIG. 2A shows an example content-defined tree, in accordance with one or more embodiments.

FIG. 2B shows multiple example content-defined trees that may be used to represent a data object and efficiently determine locations of chunks that may be used to recreate the data object, in accordance with one or more embodiments.

FIG. 2C shows example content-defined trees that may be used to generalize data across multiple databases, in accordance with one or more embodiments.

FIG. 2D shows an example scalable data structure for binary file deduplication, in accordance with one or more embodiments.

FIG. 3 shows illustrative components for a system that may use content-defined trees, in accordance with one or more embodiments.

FIG. 4A shows a flowchart of steps involved in generating content-defined trees, in accordance with one or more embodiments.

FIG. 4B shows a flowchart of steps involved in generating a scalable data structure for binary file deduplication, in accordance with one or more embodiments.

FIG. 4C shows a flowchart of steps involved in deduplicating (e.g., in response to an “insert” operation request) new content using a previously generated scalable data structure for binary file deduplication, in accordance with one or more embodiments.

FIG. 5 shows a flowchart of steps involved in retrieving chunks for reconstructing a data object using a previously generated scalable data structure for binary file deduplication, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

### Content-Defined Trees

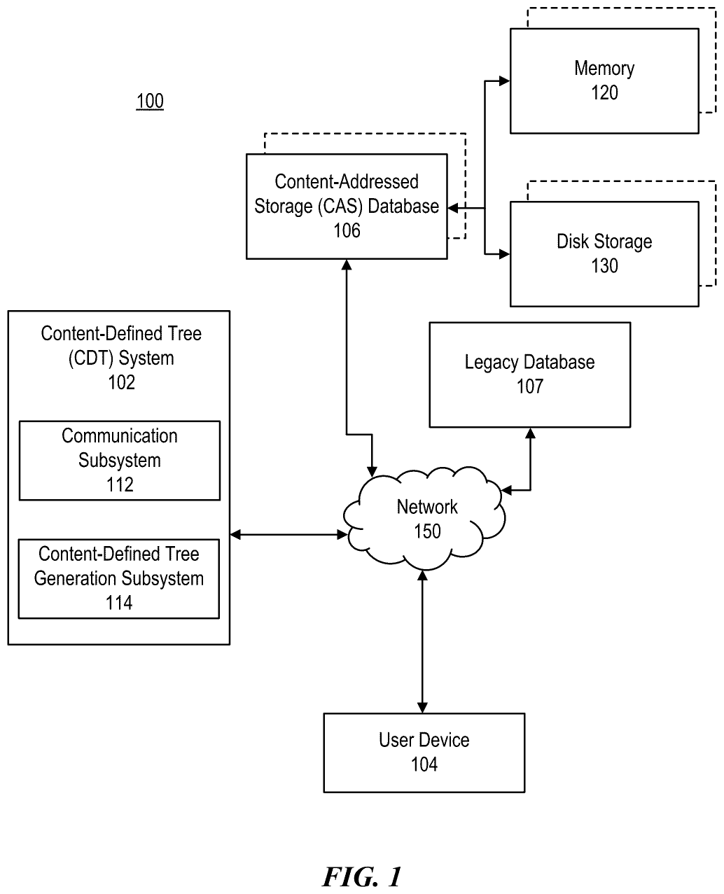

FIG. 1 shows an illustrative system 100 that may address the above-described problems, for example, through the use of content-defined trees. A content-defined tree may be a tree of cryptographic hashes (e.g., SHA-3, Whirlpool, RIPEMD-160, etc.) where each leaf is a hash of a chunk (e.g., data chunk) of a data object, and each parent node (e.g., interior node) is the hash of a concatenation of the hashes of its children nodes. To create parent nodes for the leaf nodes, a computing system may group leaf nodes together based on a rolling hash (e.g., a rolling hash of the hashes of the leaf nodes) satisfying a condition. Each parent node may include a hash that represents the concatenation of the hashes of the leaf nodes that fall under the corresponding parent node.

Through the use of a content-defined tree, the system 100 may be able to efficiently index data while preserving the ability to also efficiently determine the differences between two data objects. For example, given a hash of a data chunk and a parent node, the system 100 may be able to efficiently determine whether a particular data object includes the data chunk. Further, the system 100 may be able to more efficiently compare two data objects using content-defined trees because a hash match at a parent node may indicate that all children nodes (e.g., and underlying data chunks) match. This may allow the system 100 to quickly move on to subsequent branches of the content-defined trees. As an extension of this benefit, through the use of content-defined trees, the system 100 may be able to more efficiently work with partial data objects. For example, if only the beginning portion of a data object is needed, the system 100 can download just the first (e.g., left) branch of the tree without downloading other portions. By doing so, the system 100 may reduce network traffic and reduce the need for additional network resources (e.g., bandwidth, throughput, etc.). As a further extension of this benefit, by storing at least some items associated with content-defined trees in disk storage 130 (also referred to as disk-based storage and/or on-disk storage) and processing only the relevant portions of content-defined trees in memory 120, the system 100 enables the scaling of content-defined trees beyond the memory 120 of a particular physical or virtual machine associated with a particular CAS database.

As shown, the system 100 may include a content-defined tree system 102 (CDT system 102), a CAS database 106, a legacy database 107, and a user device 104, any of which may communicate with each other or other devices via a network 150. The CDT system 102 may include a communication subsystem 112, a content-defined tree generation subsystem 114, or other components. One of skill will appreciate that, in various embodiments, certain components can be combined or omitted. For example, in some embodiments, the legacy database 107 can be omitted. In some embodiments, certain components can be duplicated such that the system 100 may include a set containing one or more of a particular component. Generally, s “set” refers to a collection of zero, one, or more than one of a particular component, depending on the context in which the term “set” is used.

The system 100 may use one or more content-defined trees to provide the benefits of allowing data objects to be summarized, supporting middle of data object changes efficiently, and handling multiple small data objects efficiently. Through the use of a content-defined tree, the system 100 may be able to produce a summary data structure for each data object (e.g., file, such as an input file) that can allow deltas (e.g., differences between data objects) to be computed efficiently without complete access to the original source data object and/or without loading the entire source data object into memory. In addition, content-defined trees may allow the system 100 to produce large data chunks (e.g., chunks greater than a threshold size) which are more efficient to store and manage. Further, by representing a data object as a content-defined tree, the system 100 may be more tolerant to insertions and deletions in the middle of data objects. Finally, through the use of content-defined trees, the system 100 may minimize the overhead (e.g., network traffic, etc.) that comes when multiple small data objects are compared or otherwise used. Accordingly, the system 100 may use content-defined trees to permit users to rename, reorganize, and move data objects around without incurring large transmission costs.

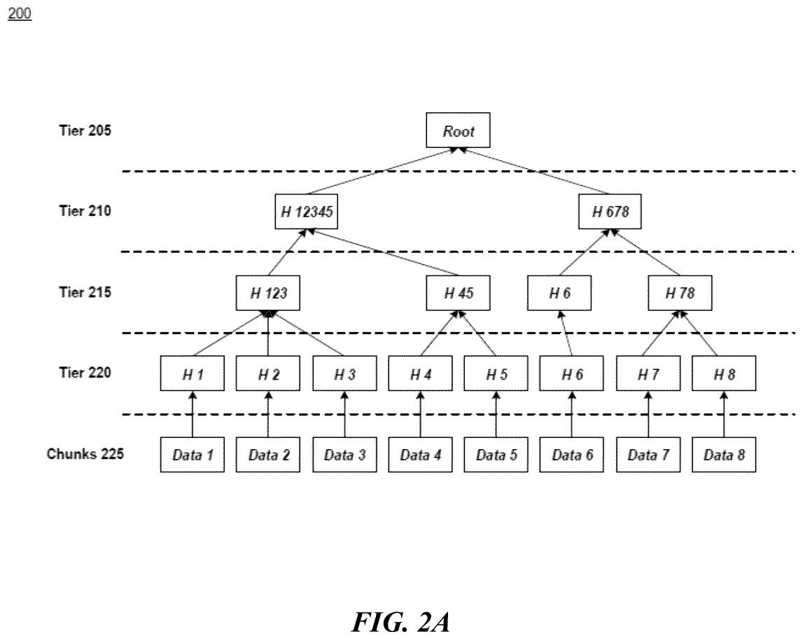

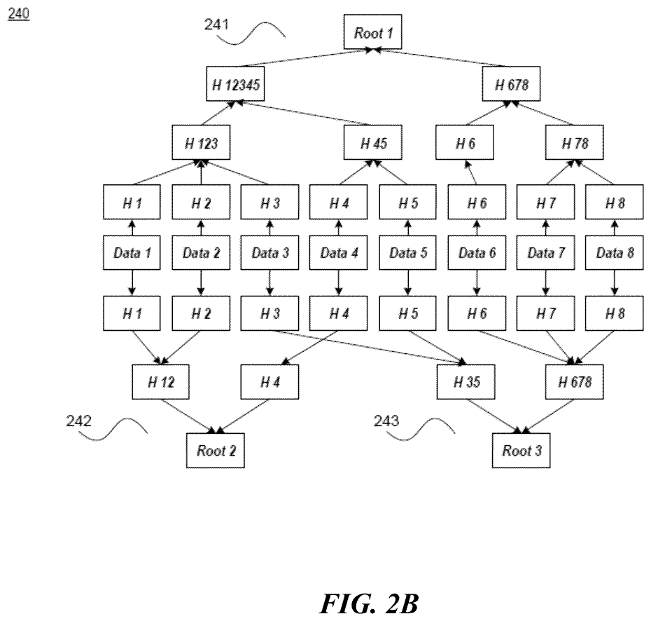

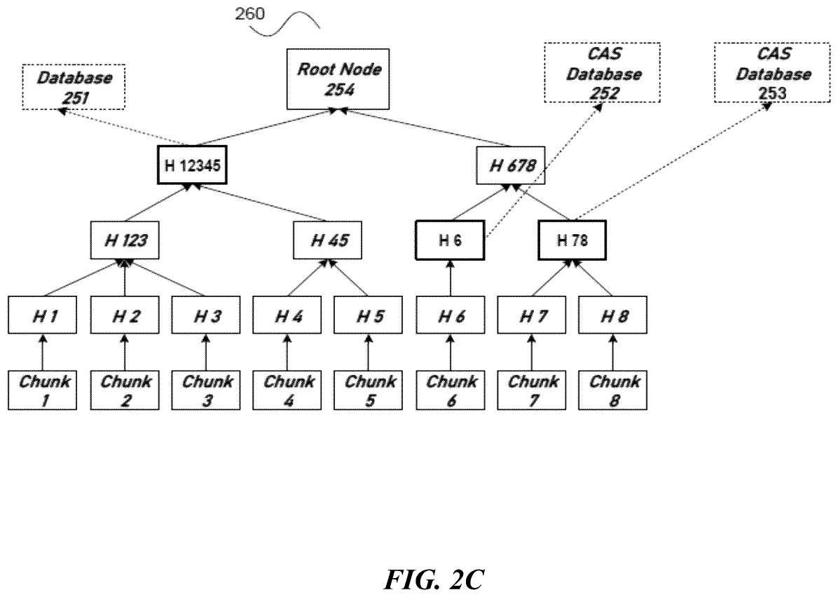

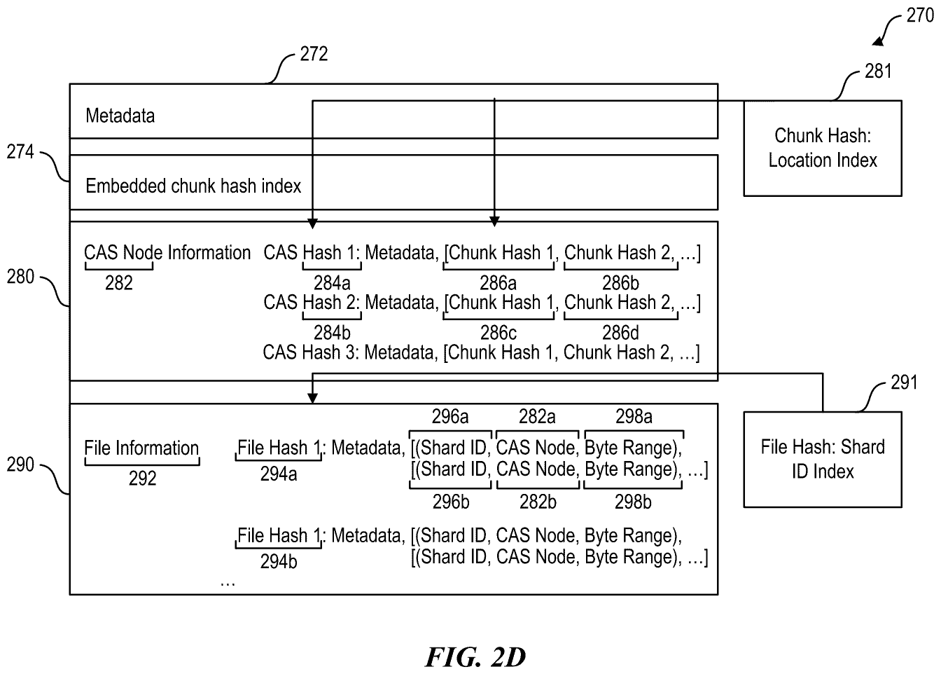

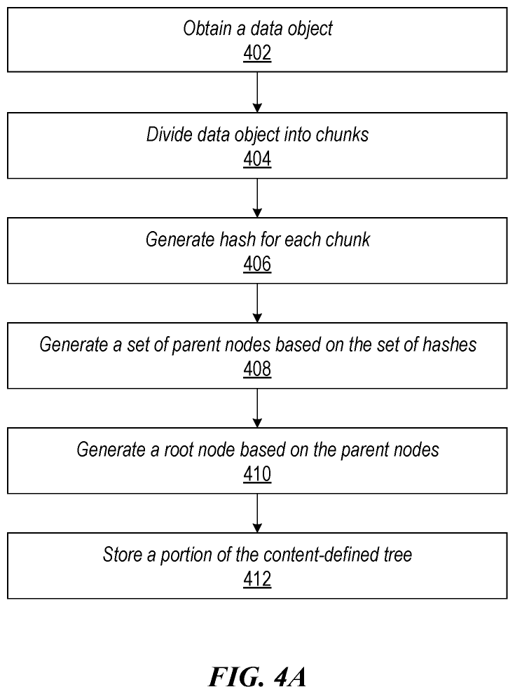

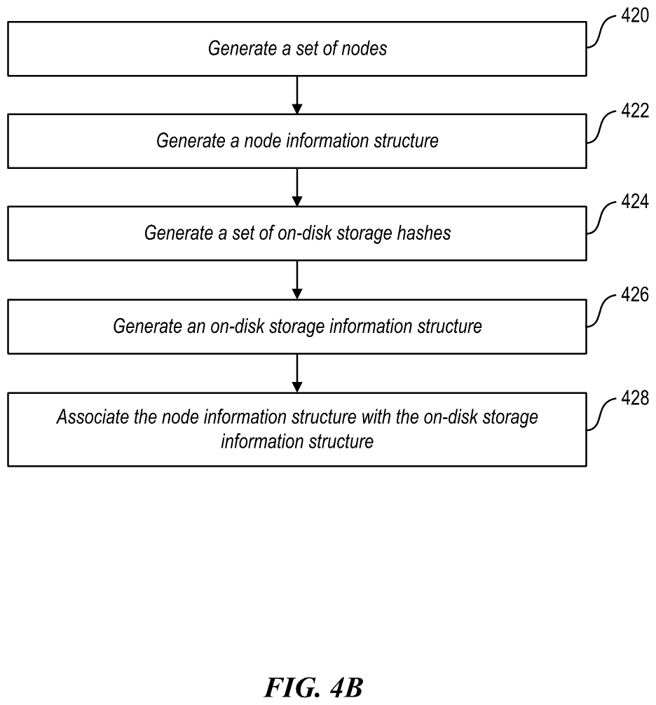

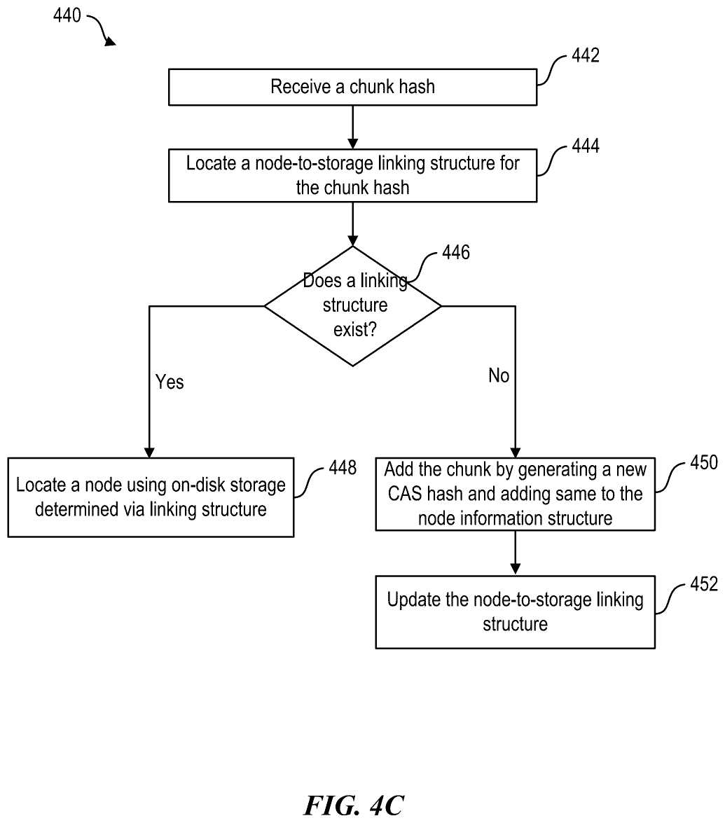

Referring to FIG. 2A, an example content-defined tree 200 is shown. The content-defined tree 200 may be generated by a computing device such as the CDT system 102 (e.g., as described in connection with FIG. 1 or FIGS. 4A-4C). The example content-defined tree 200 may include a plurality (e.g., four) tiers 205-220 and may be based on the chunks 225. The chunks 225 may have been generated based on a data object (e.g., input file) as described in more detail below (e.g., using a rolling hash or condition). Tier 220 may include a set of hashes H1-H8. Each hash in tier 220 may correspond to a particular one chunk of the chunks 225. For example, the hash H1 may correspond to the chunk labeled Data 1, the hash H2 may correspond to the chunk labeled Data 2, and so on. Each hash in tier 220 may be a cryptographic hash or a variety of other hashes.

The hashes in tier 220 may be grouped together using a rolling hash and condition, for example, as described in more detail below in connection with FIG. 1. The hashes in tier 220 can be referred to as the leaf nodes of the content-defined tree 200, for example, because they are the bottom most nodes in the content-defined tree (e.g., they are direct hashes of the chunks 225). The groups of hashes may be used to generate parent nodes that form tier 215. For example, based on a condition and a rolling hash, the CDT system 102 may determine that hashes H1-H3 belong in one group. The CDT system 102 may concatenate each of hashes H1-H3 and a message authentication code (MAC) of the hashes H1-H3. The CDT system 102 may then generate a hash of the resulting concatenation (e.g., that includes hashes H1-H3 and the MAC) to form the hash for the parent node H123. The CDT system 102 may determine, based on a hash of a concatenated hash of H4 and H5, that both H4 and H5 should be grouped together. In response, the CDT system 102 may generate the parent H45 and a hash that is based on the concatenation of the hashes of H4 and H5. A hash of the hash H6 may satisfy the grouping condition, and thus the CDT system 102 may generate a parent node in tier 215 that corresponds to H6. Hashes H7 and H8 may be used to generate an additional parent node in Tier 215.

The CDT system 102 may generate an additional tier 210 that includes parent nodes of the parent nodes in tier 215. The parent nodes in tier 210 may be generated in a similar manner that the parent nodes in tier 215 were generated. For example, a hash of a concatenation of the hashes in H123 and H45 may satisfy the grouping condition. Based on the grouping condition being satisfied, the CDT system 102 may generate the parent node H12345 which may be based on a hash of the concatenation of the hashes stored in parent nodes H123 and H45. A root node may be generated and may include a hash that is based on the hashes stored in parent nodes H12345 and H678.

Referring back to FIG. 1, the CDT system 102 may obtain a data object (e.g., via the communication subsystem 112). As used herein, a data object may be a collection of one or more data points that create meaning as a whole. A data object may include a data structure, a file, a blob, a hash, a collection of memory addresses or the contents of the memory addresses, or a variety of other data objects. The data object may include a string of bytes. The data object may correspond to a file (e.g., CSV, PDF, SQL, or a variety of other file types—for example, file types from the legacy database 107 or another computing system or application). The data object may be associated with a repository of data. For example, the data object may be one file in a directory containing other files.

The CDT system 102 may divide the data object into chunks. For example, the CDT system 102 may divide a particular string of bytes into a set of chunks, each chunk in the set of chunks having a boundary. Each boundary may define the size of a corresponding chunk. As used herein, a chunk may be a portion of a data object. A chunk may be a fragment of information which may be used in a variety of multimedia file formats. A chunk may include a header which indicates some parameters. A chunk may include a variable area containing data, which, for example, may be decoded by a computing device using parameters in the header.

In some embodiments, a boundary for a chunk may be determined based on a rolling hash and a condition. A rolling hash may be a hash function where the input is hashed in a window that moves through the input. For example, the input for the rolling hash may be taken from the contents of a data object. In one example, the rolling hash may start with a portion of the data object (e.g., a minimum amount, an amount greater than a threshold amount, which may be 16 kilobytes in some examples) and a hash may be generated based on the portion. The CDT system 102 may compare the generated hash with a condition. For example, the condition may require the generated hash to be less than a threshold value. If the generated hash does not satisfy the condition, the CDT system 102 may add additional data from the data object to the portion used as input to the rolling hash resulting in an extended portion. A new hash may be generated for the extended portion and the condition may be checked again for the new hash. If the condition is satisfied, the CDT system 102 may designate the extended portion as a chunk and the process may continue with the remainder of the data object until the data object is fully divided into chunks.

In some embodiments, the CDT system 102 may set a maximum or minimum chunk size. If the input to the hash function satisfies the maximum chunk size, the CDT system 102 may designate the input as a chunk regardless of whether the condition is satisfied or not. In some embodiments, the CDT system 102 may make sure that no chunk is smaller than a minimum chunk size (e.g., no less than 16 KB, etc.).

By dividing the data object into chunks, the CDT system 102 may be able to use the chunks to generate a content-defined tree and may provide a data object storage solution that is able to more efficiently handle insertions or deletions made in the middle of the data object. For example, dividing the data object into chunks in this way may allow for insertions and deletions to be made in the middle of the data object without altering every chunk boundary and may prevent the need for the CDT system 102 to recompute every chunk for the data object.

The CDT system 102 may generate a hash for each chunk of the data object. For example, the CDT system 102 may generate a set of hashes that includes a cryptographic hash for each chunk. The set of hashes may form a first tier (e.g., a bottom tier 220) of a content-defined tree.

The CDT system 102 may generate a set of parent nodes based on the set of hashes. The CDT system 102 may assign each hash of the set of hashes to a group based on a rolling hash and a condition. The condition may be a test on the node hash to cause an average branching factor or average group size (e.g., 4 hashes per group on average with one group belonging to one parent node).

In some embodiments, a boundary for a parent node (e.g., the number of child nodes that are assigned to one parent node) may be determined based on a rolling hash and a condition. The rolling hash may be any rolling hash function described above (e.g., a hash function where the input is hashed in a window that moves through the input). For example, the input for the rolling hash may be data stored in the leaf nodes (e.g., the hashes of each chunk of the data object). In one example, the rolling hash may start with the hash of a first leaf node and a hash of the hash of the first leaf node may be generated. The CDT system 102 may compare the hash of the hash with a condition. For example, the condition may require the hash of the hash to be less than a threshold value. As an additional example, the condition may require the hash of the hash to be greater than a threshold value. As an additional example, the condition may require the last two bits of the hash to be greater than or less than a threshold value.

If the generated hash does not satisfy the condition, the CDT system 102 may concatenate the hash of the first leaf node with the hash of a second leaf node. The CDT system 102 may use the concatenated hash as input to the hash function. A hash of the concatenated hash may be generated and the condition may be checked again for the hash of the concatenated hash. If the condition is satisfied, the CDT system 102 may assign the first and second leaf nodes to a parent node. The hash stored by the parent node may be the hash of the concatenated hash. In this way the parent node may represent the first and second leaf nodes. The process may continue until all leaf nodes are assigned to a parent node. The CDT system 102 may continue generating the content-defined tree by generating parent nodes of parent nodes, for example, as described in connection with FIG. 2A. The process may continue until a root node is generated (e.g., all parent nodes at a particular tier are assigned to one root node).

In some embodiments, the CDT system 102 may set a maximum or minimum number of nodes that may belong to any one parent node. For example, if the maximum number of nodes is four, the CDT system 102 may limit the number of nodes that are directly linked (e.g., through adjacent tiers) to a parent node to four. For example, a parent node in a first tier may have no more than four children nodes in a second tier that is immediately below the first tier (e.g., with no tiers in between the first and second tier).

In some embodiments, the CDT system 102 may take extra measures to prevent hash collisions. For example, a hash of a concatenated hash described above may be based on a MAC corresponding to the concatenated hash. When generating a hash for a parent node, for example, the CDT system 102 may concatenate each hash of the children nodes of the parent node (e.g., the children nodes that form the tier immediately below the parent node) to form a concatenated hash. The CDT system 102 may further concatenate a MAC with the concatenated hashes. The CDT system 102 may generate the MAC based on the concatenated hash. For example, the CDT system 102 may use the concatenated hash as the basis for the MAC. In one example, the CDT system 102 may generate a hash of a MAC together with a corresponding concatenation of each hash in a group of hashes. In this example, both the MAC and group of hashes may be input into the hashing function to generate a single hash. By doing so, the CDT system 102 may ensure that for any two different strings (e.g., hashes, groups of hashes, etc.) there are no collisions. This may prevent two different chunks, groups of chunks, or parent nodes from having the same hash.

In some embodiments, additional constraints may be used to force the number of hashes per parent node (e.g., per group) to be between two and eight, inclusive. In one example, a group of child nodes may correspond to one parent node in the set of parent nodes. The CDT system 102 may concatenate each hash in the group of child nodes. The CDT system 102 may generate a hash of the concatenated hashes to form the hash of the parent node of the group of hashes (e.g., the parent node may be the hash of the concatenated hashes). Each parent node may include a hash that is usable as a key to retrieve each hash in the corresponding group of hashes. For example, a first parent node may include a hash that may key to a data structure that includes each hash of the group of hashes that was used to generate the first parent node. The parent nodes may form a second tier of the content-defined tree. A content-defined tree may have any number of tiers of child nodes or parent nodes.

The CDT system 102 may generate a root node based on the parent nodes generated at step 408. For example, the CDT system 102 may merge each of the parent nodes to form the root node. In one example, the CDT system 102 may generate the root node by applying a rolling hash with a condition to a set of parent nodes. Based on applying the rolling hash, the CDT system 102 may determine that each parent node in the set of parent nodes should be combined into one group. In response, the CDT system 102 may concatenate each of the parent nodes (e.g., the hashes of the parent nodes) and generate a hash of the concatenation. The root node may comprise the hash of the concatenation. In some embodiments, the concatenation may include a MAC generated based on hashes of the parent nodes.

The CDT system 102 may store a portion of the content-defined tree (e.g., in the CAS database 106). As described below, a particular portion of the content-defined tree or a data structure relating thereto (e.g., a linking structure, an on-disk storage structure) can be stored in the memory 120, on disk storage 130, or both.

In some embodiments, the CDT system 102 may generate a content-defined tree that includes multiple files or an entire data repository. For example, a data object obtained by the CDT system 102 may be part of a set of data objects that is stored in a data repository. The CDT system 102 may generate, based on the data repository, a metadata store comprising a directory layout and metadata of the data repository. The CDT system 102 may generate a byte stream comprising a concatenation of all bytes of all data objects in the data repository. The concatenation may be sorted in hash order. The CDT system 102 may generate a second content-defined tree based on the byte stream. In some embodiments, the CDT system 102 may insert a chunk boundary at an end of each data object in the data repository. This may cause a new chunk to be created for the beginning of every data object or file in the repository.

In some embodiments, the data repository may correspond to a dataset for training a machine learning model. The CDT system 102 may use the content-defined tree to split the data repository into train, test, validation, or other sets to use in training the machine learning model. The CDT system 102 may designate a first portion of the set of parent nodes as a training dataset and a second portion of the set of parent nodes as a testing dataset, and train the machine learning model using the training dataset and the testing dataset.

In some embodiments, the CDT system 102 may use the content-defined tree to compare data objects to determine a difference between the data objects. For example, the CDT system 102 may determine, based on a comparison of the content-defined tree with a second content-defined tree, that the data object has been modified. Based on the modification to the data object, the CDT system 102 may update a hash of a parent node of the set of parent nodes to include the modification. For example, one or more new chunks may be generated for the data object because of the modification made to the data object. A new hash may be created for a new chunk and may be inserted into the content-defined tree. Any parent nodes of the new hash may be generated based on the changes.

### Content-Addressed Storage (CAS)

The system 100 may use one or more content-defined trees to indicate where each of a data object's chunks may be found in a storage system by mapping hashes of chunks to storage locations (e.g., memory addresses). By doing so, the system 100 may provide a storage architecture that can efficiently handle small files, sparse diffs, and large files.

To do so, the CAS database 106 may be used. The CAS database 106 may be a key-value store where the key may be based on a hash of a corresponding chunk. A hash of a chunk may be used to determine the location and retrieve the chunk. For example, by storing appropriate nodes of a content-defined tree in the CAS database 106, the CDT system 102 may be able to recover the contents of any hash in a content-defined tree.

As shown, a particular CAS database 106 may include or be communicatively coupled to one or more of a memory 120 and disk storage 130. The memory 120 may include one or more types of random access memory (RAM). For example, the memory 120 can include one or more of a volatile semiconductor memory device such as dynamic random-access memory (DRAM), synchronous dynamic random-access memory (SDRAM), double data rate SDRAM (DDR SDRAM), static random-access memory (SRAM), T-RAM, Z-RAM, and so forth. The memory 120 may also include cache memory. Cache memory is generally a form of computer memory placed in close proximity to a processor (e.g., a processor associated with a particular CAS database 106) for fast access times. In some implementations, the cache memory may include memory circuitry that can be part of, or on the same chip as, a particular processor. In some implementations, there are multiple levels of cache memory, e.g., L2 and L3 cache layers. In some implementations, multiple processors, and/or multiple cores of a processor, can share access to the same cache memory. The disk storage 130 may include one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof.

The CAS database 106 may store content-defined trees that may be used to find addressable locations (e.g., in memory 120 or on disk storage 130) where chunks may be found. The content-defined trees stored in the CAS database 106 may be referred to as CAS trees. Other content-defined trees may be used to keep track of what chunks belong to what data objects. For example, a content-defined tree may correspond to a data object and may identify each chunk that can be used to recreate the data object. By comparing the nodes of the content-defined tree that represents the data object with nodes of one or more CAS trees, the CDT system 102 may be able to determine where the chunks may be found, for example, so that the data object can be reconstructed.

For example, referring to FIG. 2B, multiple example content-defined trees that may be used to represent a data object and efficiently determine locations of chunks that may be used to recreate the data object are shown. The content-defined tree 241 may include a first tier of child nodes H1-H8, a second tier of parent nodes H123-H78, a third tier of parent nodes H12345-H678, and a root node Root 1. The content-defined tree 241 may be associated with the data object that includes chunks Data 1-Data 8. The CDT system 102 may use the content-defined tree 241 to determine chunks needed to recreate the data object, for example, if a request for the data object is received.

To distinguish from the content-defined tree 241, which may be specific to the data object represented by chunks Data 1-Data 8, trees 242 and 243 may be referred to as CAS trees 242 and 243. The CAS tree 242 and the CAS tree 241 may be generated in a similar or the same manner as a content-defined tree described in connection with FIG. 1 (e.g., using a rolling hash and condition to group nodes and generate parent nodes). The CAS tree 242 may correspond to multiple chunks including Data 1, Data 2, and Data 4. The CAS tree 243 may correspond to multiple chunks including Data 3, Data, 5, Data 6, Data 7, and Data 8. The nodes of the CAS trees (e.g., nodes H1-H8) may be used to look up the memory locations of the corresponding chunks. For example, the hash of node H1 may be used as a key to retrieve a value indicating a location where the chunk Data 1 is stored in memory.

The CDT system 102 may compare the nodes of the content-defined tree 241 with nodes of the CAS tree 242 or the nodes of the CAS tree 243 to determine where to find the chunks of the corresponding data object. In one comparison, by comparing the hash of the node H678 of the content-defined tree 242 with the hash of the node H678 of the CAS tree 243, the CDT system 102 may determine the locations of the chunks Data 6, Data 7, and Data 8 (e.g., because the hashes match). The CDT system 102 may use a tree search (e.g., breadth first search) approach to compare the nodes of different trees, allowing data to be found more efficiently. For example, because each node's hash is based on hashes of underlying nodes, if a parent node in a content-defined tree matches a parent node in a CAS tree, the locations of each chunk corresponding to any node below the parent node (e.g., any child node) may be determined without the need to compare each child node individually.

Referring back to FIG. 1, the CDT system 102 may obtain a request for a data object. The request may be sent by a user device. For example, the user device may send a request with an identification of a file to the CDT system 102.

The CDT system 102 may retrieve a content-defined tree corresponding to the requested data object. The content-defined tree may include any aspect described above (e.g., in connection with FIG. 1 or FIGS. 4A-4C). For example, the content-defined tree may include a set of parent nodes, with each parent node corresponding to a set of hashes that have been determined using a rolling hash and a grouping condition. Each parent node may include a hash of a concatenation of each hash in a corresponding set of hashes. The set of parent nodes may form a tier of the content-defined tree. Each hash in each set of hashes may correspond to a chunk in the data object.

In one example, each data object may be associated with a content-defined tree that includes a set of leaf nodes. The set of leaf nodes may include a leaf node for each chunk (e.g., portion) of the data object. In some embodiments, the identification of a data object may include the hash of the root node of the content-defined tree. The CDT system 102 may retrieve the content-defined tree by searching a database for the hash and obtaining a set of nodes (e.g., parent nodes, leaf nodes, etc.) that are connected to the root node. Using a content-defined tree that is specific to the data object may allow the CDT system 102 to efficiently determine all of the chunks that belong to the data object (e.g., all of the chunks that may be needed to reconstruct the data object). Further, a content-defined tree that is specific to the data object may allow the CDT system 102 to more efficiently determine the locations of each chunk within a database. This may be possible, for example, because the content-defined tree can be compared with other content-defined trees that are part of a CAS system as described in more detail below.

The CDT system 102 may traverse the content-defined tree. Traversing the content-defined tree may allow the CDT system 102 to determine whether a CAS tree stored in a database includes a node that matches a node in the content-defined tree. For example, the CDT system 102 may traverse the content-defined tree by obtaining the root node of the content-defined tree. The root node may be compared with nodes in the CAS database 106. If a matching node is found, the CDT system 102 may use the matching node in the CAS database 106 to find the locations of chunks that may be used to reassemble the data object.

The CDT system 102 may compare a node from the content-defined tree with a set of nodes. The set of nodes may correspond to other trees (e.g., CAS trees) stored in a database. In some embodiments, comparing a first node from the content-defined tree with a second node (e.g., corresponding to a CAS tree) may include comparing a first hash of the first node with a second hash of the second node. If the first hash and the second hash are the same, the CDT system 102 may determine that the CAS tree corresponding to the second node can be used to locate one or more chunks of the data object that correspond to the content-defined tree.

By comparing the nodes in this way, the CDT system 102 may be able to more efficiently determine the locations of chunks to reconstruct the data object because comparing hashes from nodes in a tree enables the CDT system 102 to quickly determine large portions of a data object. For example, if a parent node of a CAS tree matches a node in the content-defined tree, the CDT system 102 may retrieve all nodes (e.g., all parent nodes and leaf nodes) that fall under the matching parent node. This may enable the CDT system 102 to find many chunks at once, instead of searching for each chunk individually.

The CDT system 102 may traverse a second content-defined tree. The CDT system 102 may traverse a second content-defined tree, for example, based on the matching node. The second content-defined tree may be a tree that is stored in the CAS database 106 (e.g., the second content-defined tree may be a CAS tree). In one example, based on a hash of the first node matching a hash of a first CAS tree node of the set of CAS tree nodes, the CDT system 102 may traverse a first CAS tree corresponding to the first CAS tree node. In this example, the first CAS tree may include a set of parent nodes, wherein each parent node includes a hash of a concatenation of each hash in a corresponding set of hashes, and wherein each hash in each set of hashes corresponds to a chunk stored in a database. By traversing the second content-defined tree, the CDT system 102 may be able to retrieve the leaf nodes of the second content-defined tree. The leaf nodes may be used to retrieve corresponding data object chunks as explained in more detail below.

The CDT system 102 may obtain a set of child nodes (e.g., leaf nodes). For example, based on traversing the first CAS tree, the CDT system 102 may obtain a set of child nodes of the first CAS tree node. Each child node may include a hash that may be used as a key to retrieve a location of a chunk of the data object.

The CDT system 102 may retrieve the set of data object chunks. For example, the CDT system 102 may input a hash indicated by a child node into a mapping function that returns the corresponding chunk. The CDT system 102 may reconstruct or reassemble the data object using the retrieved data object chunks. For example, the CDT system 102 may arrange the chunks in order and concatenate them to generate the data object.

The CDT system 102 may generate new CAS trees, modify CAS trees, or delete CAS trees based on changes that are made to one or more data objects. The CDT system 102 may determine that a new CAS tree should be generated based on a content-defined tree for a data object. For example, after comparing the nodes of the content-defined tree with nodes in the CAS database 106, the CDT system 102 may determine that there is no corresponding node in the CAS database 106 for one or more nodes in the content-defined tree associated with the data object. The CDT system 102 may generate a new CAS tree for the nodes that do not have a corresponding node in the CAS database 106. The new CAS tree may be generated in a similar or the same manner as a content-defined tree is generated as described above. Based on no CAS tree existing for the portion of the data object, the CDT system 102 may generate a new CAS tree by dividing a portion of the data object that has no corresponding nodes in the CAS database 106 into a set of chunks. Each chunk in the set of chunks may be determined using a boundary that is determined based on a first rolling hash satisfying a first condition and each boundary defines a size of a corresponding chunk. Alternatively, if a content-defined tree has already been created for the data object, the CDT system 102 may use the nodes in the content-defined tree to create the CAS tree and may forego repetition of the data object chunking process.

In this example, generating a new CAS tree may further include generating a set of hashes comprising a cryptographic hash for each chunk of the set of chunks. The set of hashes may form a first tier of the new CAS tree. The CDT system 102 may further generate a set of parent nodes by grouping each hash of the set of hashes based on a second rolling hash satisfying a second condition, and by hashing a concatenation of each resulting group of hashes. The set of parent nodes may form a second tier of the content-defined tree. A first parent node of the set of parent nodes may include a hash that is usable as a key to retrieve each hash in a group of hashes that corresponds to the first parent node. The CDT system 102 may store the new CAS tree in the CAS database 106. The CDT system 102 may store the content-defined tree or the portion of the data object that corresponds to the new CAS tree in the CAS database 106.

In some embodiments, the CDT system 102 may limit the size of a new CAS tree that is generated. For example, based on determining that a portion of the data object (e.g., a portion that has no matching nodes in the CAS database 106) is greater than a threshold size, the CDT system 102 may generate the new CAS tree using a first subpart of the portion of the data object that is less than the threshold size. The CDT system 102 may generate a second new CAS tree using a second subpart of the portion of the data object. In one example, content of the first subpart may not overlap with the second subpart.

In some embodiments, the CDT system 102 may generate a user interface to show what nodes in a content-defined tree correspond to other nodes in a CAS tree. For example, the CDT system 102 may generate a user interface that includes a set of data object chunks and a first CAS tree. The user interface may include one or more elements that indicate an association between a node in the first CAS tree and a corresponding chunk in the set of data object chunks.

The system 100 may use content-defined trees to set intersections/subtractions of trees representing data in different databases to provide an efficient way to deduplicate data across databases. The CDT system 102 may obtain a request to integrate a legacy database with a CAS database. Integrating the legacy database with the CAS database may include making each database interoperable with each other or may include making the CAS database an extension of the legacy database. For example, the CDT system 102 may be able to use a content-defined tree to efficiently index and retrieve data object chunks that may be split between the legacy database and the CAS database (e.g., with a first portion of the chunks stored in the legacy database and a second portion of the chunks stored in the CAS database). Through the use of content-defined trees (e.g., CAS trees), the legacy database and the CAS database may be able to reduce duplication of data and thereby increase storage capacity. This may be done because the content-defined trees may be data object generic. A content-defined tree may be data object generic when a chunk indicated by the tree may be used in multiple data objects. For example, if two different data objects have an overlapping part (e.g., a portion of the data objects match, a portion of the two data objects have the same text, code, data, etc.), then a chunk that corresponds to the overlapping part may be used to reconstruct each data object and the CDT system 102 may not need to store two separate chunks (e.g., and corresponding nodes of content-defined trees) for each data object.

In some embodiments the legacy database may be owned by a first organization (e.g., company, etc.) and the CAS database may be owned by a second organization. By integrating the two databases together using content-defined trees, each organization may reduce the amount of storage space needed to store their data because any overlapping data may be safely deleted.

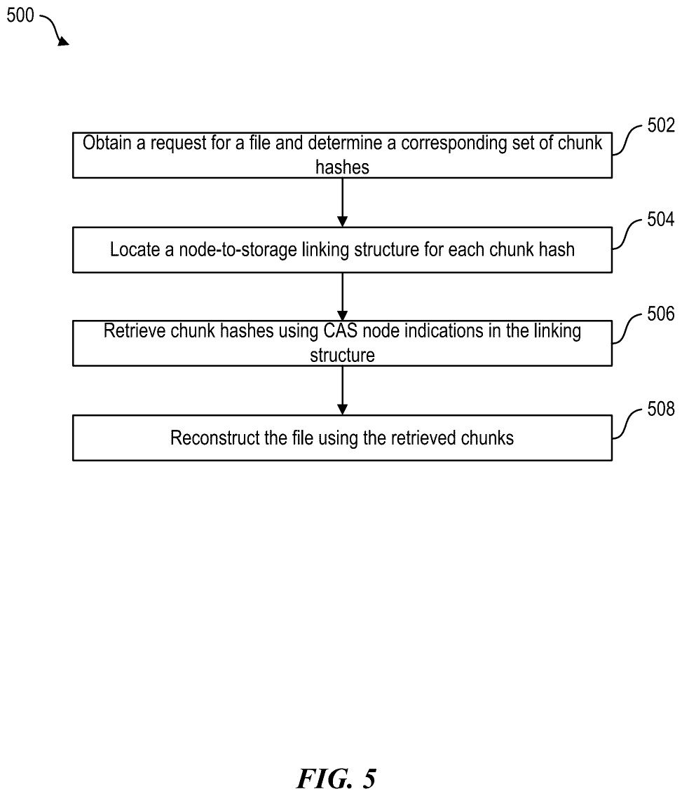

The CDT system 102 may generate a first content-defined tree for the legacy database. To enable integration of the legacy database with the CAS database, the CDT system 102 may generate one or more content-defined trees for the data stored in the legacy database. The one or more content-defined trees may be generated in a similar or the same manner as a CAS tree in the CAS database (e.g., as described above in connection with FIG. 1, FIG. 5, or other figures), except that data stored in the legacy database may be used to generate the one or more content-defined trees. In one example, the CDT system 102 may generate a first content-defined tree corresponding to the legacy database, wherein the first content-defined tree comprises a first set of parent nodes, each parent node of the first set of parent nodes corresponding to a set of hashes that have been determined using a rolling hash and a grouping condition, wherein each parent node comprises a hash of a concatenation of each hash in a corresponding set of hashes, wherein the first set of parent nodes form a tier of the first content-defined tree, and wherein each hash in each set of hashes corresponds to a portion of data in the legacy database.

The CDT system 102 may generate any number of content-defined trees for the legacy database. For example, the CDT system 102 may split all of the data in the legacy database into chunks (e.g., using a boundary condition as described in connection with FIG. 1) and generate enough content-defined trees so that each chunk is represented in a content-defined tree. Each content-defined tree may be limited to a threshold size. For example, the maximum amount of data that may be represented by a content-defined tree may be 16 Megabytes (e.g., the sum of all chunks corresponding to one content-defined tree may be no more than 16 Megabytes).

The CDT system 102 may obtain a second content-defined tree from a CAS database. The CAS database may be any CAS database described above in connection with FIG. 1. The second content-defined tree may be data object generic in that one or more chunks associated with the second content-defined tree may be used to reconstruct a variety of data objects. A child node (e.g., leaf node) of the second content-defined tree may include a hash that may be used to retrieve a storage location (e.g., memory address) of a corresponding chunk. For example, the hash may be used as a key to retrieve a value from a mapping data structure that maps hashes to memory locations. In one example, the CDT system 102 may obtain a second content-defined tree corresponding to the CAS database, wherein the second content-defined tree comprises a second set of parent nodes, each parent node in the second set of parent nodes comprising a concatenated hash corresponding to a set of leaf nodes.

The CDT system 102 may compare the first content-defined tree (e.g., corresponding to the legacy database) with the second content-defined tree (e.g., corresponding to the CAS database). The CDT system 102 may compare hashes stored in nodes of the first content-defined tree with hashes stored in nodes of the second content-defined tree.

In some embodiments, the CDT system 102 may use a top-down approach (e.g., starting by comparing root nodes, and then nodes at each tier until leaf nodes are compared). In one example, the CDT system 102 may use a breadth first search to compare nodes. If the hash of a node matches the hash of another node, the CDT system 102 may remove one of the nodes and all children nodes of the node. This may be done because each node is a hash of the hashes of corresponding children nodes. Thus, if the hashes of two parent nodes are the same, the CDT system 102 may assume that the set of leaf nodes that belong to the first parent node is the same as the set of leaf nodes that belong to the second parent node. In this way, the CDT system 102 may be able to delete or remove duplicate nodes from the first content-defined tree or the second content-defined tree and any corresponding data from the legacy database or the CAS database. For example, the CDT system 102 may first compare root nodes of a first content-defined tree in the legacy database and a second content-defined tree in the CAS database. In this example, if the root nodes match, the CDT system 102 may delete the root node, any child nodes of the root node, and any data object chunks that correspond to the child nodes of the root node from the CAS database. By doing so, the CDT system 102 may be able to determine and remove duplicate data more efficiently because comparing parent nodes allows comparison of corresponding children nodes without the need to compare each child node or each data object chunk individually.

The CDT system 102 may remove duplicate nodes from the first content-defined tree or the second content-defined tree. For example, the CDT system 102 may remove a node (e.g., as well as any child nodes of the node) from the second content-defined tree, if the node is present in the first content-defined tree. The CDT system 102 may remove any chunks that correspond to the removed node from a database (e.g., the legacy database or the CAS database). In one example, based on comparing the first content-defined tree with the second content-defined tree, the CDT system 102 may remove a duplicate portion of data from the legacy database or the CAS database.

FIG. 2C shows example content-defined trees that may be used to generalize data across multiple databases. A data object may be represented by the content-defined tree 260. Different portions of the chunks 1-8 used to create the content-defined tree 260 may be found in different databases. For example, the portion of the content-defined tree under node H12345 may be found in database 251. A CAS tree that includes H12345 as the root node may be found in database 251. The chunks 1-5 may be retrieved by the CDT system 102 from the database 251, for example, if the CDT system 102 receives a request for the data object. Chunk 6 and its corresponding parent node H6 may be found in CAS database 252. Chunks 7-8 and their corresponding parent node may be found in CAS database 253. In some embodiments, the CDT system 102 may retrieve a data structure that indicates the locations of each CAS tree or content-defined tree in each database. To reconstruct the data object that includes chunks 1-8, content-defined tree 260 may be traversed to find the data sources (e.g., the database 251, the CAS database 252, and the CAS database 253).

### Scalable Data Structure for Content-Addressed Storage (CAS)

FIG. 2D shows an example scalable data structure, such as a node-to-storage linking structure 270 for binary file deduplication, in accordance with one or more embodiments. By storing at least some items associated with content-defined trees in disk storage 130 of FIG. 1 and processing only the relevant portions of content-defined trees in memory 120, scalable data structures enable scaling of content-defined trees beyond the memory 120 of a particular physical or virtual machine associated with a particular CAS database 106.

The scalable data structures may accomplish this task by distributing information between multiple shards. A shard can be thought of as a collection of CAS nodes. A shard can include any suitable combination of a vertically or horizontally segmented content-defined tree, such as, for example, a root node and all or some branches therein, a parent node and all or some branches therein, a collection of nodes corresponding to a particular tier (205, 210, 215, 220) of a content-defined tree (e.g., a tree of FIG. 2A), and so forth. In some embodiments, a particular CAS database 106 stores a plurality of shards. In some embodiments, a particular CAS database 106 can be thought of as an entity that corresponds to a particular shard. For example, a particular CAS database 106 can be an instance of a larger database, where the instance holds a particular partition of data contained within a shard, resulting in a technical benefit of spreading the processing load across multiple instances of the CAS database 106.

An example node-to-storage linking structure 270 discussed herein is an on-disk data structure, which can be retrievably stored on one or more elements of the disk storage 130 of FIG. 1. One of skill will appreciate that, as part of the creation, retrieval and processing (e.g., updating, deduplication) of CAS nodes, various portions of a node-to-storage linking structures 270 can be loaded into one or more elements of the memory 120 of FIG. 1 and manipulated therein. For example, the CAS hashes included in node-to-storage linking structures 270 can be generated entirely in the memory 120 of FIG. 1 prior to being stored on disk. As another example, in response to a particular data retrieval request, appropriate (sufficient for file reconstruction) portions of the CAS hashes included in the node-to-storage linking structures 270 can be retrieved from disk storage 130 and loaded into the memory 120 for processing therein.

Node-to-storage linking structures 270 can be implemented as linked lists, collections of key-value pairs, sets of tables in relational databases, or as other suitable data structures. As shown, an example node-to-storage linking structure 270 may include or be associated with header information (272, 274), CAS node information 280, and file information 290.

The header information can include metadata 272 and/or an embedded chunk hash index 274. The metadata 272 may include various information about a particular node-to-storage linking structure 270, such timestamp data, location data (e.g., a shard identifier, an addressable location of the node-to-storage linking structure 270 on disk), MAC of hashes and so forth. The embedded chunk hash index 274 may include an ordered list of hashes or truncated hashes stored in the node-to-storage linking structure 270 (e.g., the hashes or truncated hashes stored as part of the CAS node information 280). The embedded chunk hash index 274 enables the technical benefit of reducing data retrieval time. For instance, embedded chunk hash indexes 274 may be retrieved from disk storage 130 and loaded into memory 120. The retrieved embedded chunk hash indexes 274 (for example, along with their corresponding metadata 272) may be traversed to quickly locate node-to-storage linking structures 270 where particular chunk hashes are stored, without loading the entirety of node-to-storage linking structures 270 into the memory 120. Once the relevant particular node-to-storage linking structures 270 are located, the system may reference the metadata 272, loaded into the memory 120, to locate the corresponding node-to-storage linking structures 270 in disk storage 130.

The CAS node information 280 may be a section in a particular node-to-storage linking structure 270. Generally, the CAS node information 280 may include information sufficient to reconstruct the nodes and their dependencies in a shard represented by a particular node-to-storage linking structure 270. As shown, in a particular node-to-storage linking structure 270, the CAS node information 280 can include an identifier of CAS node 282 (e.g., in the form of a hash or an item that includes a hash). The CAS node 282 may be a higher-level (e.g., root, parent) node, and may be stored relationally to a set of CAS hashes (284a, 284b) which, collectively, may form the CAS node 282 (e.g., by being concatenated and/or hashed as a unit). The CAS hashes (284a, 284b) in the set of CAS hashes may be stored relationally to sets of chunk hashes (286a-286d), which, collectively, can form a particular CAS hash (284a, 284b) by being concatenated and/or hashed as a unit. In an example, the chunk hashes (286a-286d) can correspond to items in the leaf tier 220 for FIG. 2A, the CAS hashes (284a, 284b) can correspond to items in the parent tier 215, and the CAS node 282 can correspond to items in the parent tier 210 and/or root tier 205.

The CAS node information 280 may be stored relationally to the chunk-to-location lookup index 281, also referred to as the node index, which enables deduplication and retrieval of data. The chunk-to-location lookup index 281 may store a set of relations (e.g., in the form of key-value pairs, delimited data records, and so forth) between chunk hashes (286a-286d) and their corresponding CAS hashes (284a, 284b). Accordingly, to determine where a particular chunk of information from object data is stored, the system may, after receiving or generating a chunk hash and locating a particular shard (e.g., locating a particular node-to-storage linking structure 270 using embedded chunk hash indexes 274 for a set of node-to-storage linking structures 280), reference the chunk-to-location lookup index 281. If a particular chunk is found (e.g., in response to a request to update/modify a particular data object), then the system can forgo the creation and storage of a new hash for the chunk. If a particular chunk is not found (i.e. the particular chunk represents a new data object or an addition to an existing data object), the system can create a new hash for the chunk and update the CAS node information 280 for a particular node-to-storage linking structure 270 (e.g., one that stores neighboring or related chunks, the most recently created one, and so forth). Updating the CAS node information 280 may trigger updating the file information 290 as discussed below.

The file information 290 may include information (e.g., on-disk addressing information) sufficient to reconstruct the data that corresponds to CAS nodes in the node-to-storage linking structures 270. The file information 290 may be a section in a particular node-to-storage linking structure 270 or a stand-alone data structure. For example, in some embodiments, a particular node-to-storage linking structure 270 may include one each of a CAS node information 280 (relating to a particular shard) and the corresponding file information 290, where the file information 292 relates to on-disk addressing information needed for reconstruction of data for only one a particular shard. In another example, a particular file information 290 structure can be a stand-alone global data structure linkable to multiple shards (e.g., linkable to multiple, different units of CAS node information 280).

As shown, a particular file information 290 structure may include file information 292 (also sometimes referred to as an on-disk storage identifier), which can pertain to one or more of a particular data object (file) and may include or be based (e.g., include in a hashed form) information sufficient to identify a particular data object (file) in a file system. Examples of such information may include a file path, file name, memory address, other unique address, and/or a combination thereof. The file information 292 may be stored relationally to a set of file hashes (294a, 294b). The file hashes (294a, 294b) can include concatenations or hashed concatenations of the following items that, collectively, allow for reconstruction of a particular data object: metadata (e.g., data-object related metadata), shard identifier (296a, 296b), CAS node (282a, 282b) identifier, and the corresponding byte range for chunks encoded in the CAS node (282a, 282b). Here, shard identifiers (296a, 296b) may point to shard identifier values in the metadata 272, which can be addressable location identifiers of the corresponding node-to-storage linking structures 270 on disk.

The file information 290 may be stored relationally to the storage-to-shard lookup index 291, which facilitates reconstruction of data. The storage-to-shard lookup index 291 may store a set of relations (e.g., in the form of key-value pairs, delimited data records, and so forth) between shard identifiers (296a, 296b) and their corresponding file hashes (294a, 294b). According to a first example, to reconstruct a data object, the system can generate or receive its file hash. The system may then look up the received or generated file hash in the storage-to-shard lookup index 291. If the file hash is found among the file hashes (294a, 294b), then the system may traverse the file information 290 to determine the corresponding set of shard identifiers (296a, 296b), CAS nodes (282a, 282b), and byte ranges. Using the shard identifiers (296a, 296b), the system may load into memory 120 the requisite CAS node information 280 entities and their corresponding chunk-to-location lookup indexes 281. Using a particular chunk-to-location lookup index 281, the system may then identify particular chunk hashes (286a-286d) in the in-memory CAS node information 280. After the needed chunk hashes (286a-286d) are identified, the system may use them to reconstruct one or more portions of the data object that correspond to the indicated byte range (298a, 298b).

By identifying the CAS nodes in this way, the system may be able to more efficiently determine the locations of chunks to reconstruct a particular data object because comparing hashes from nodes in a tree enables the computing system to quickly determine large portions of a data object. For example, once the system has identified the CAS nodes (282a, 282b) for which CAS node information 280 should be loaded into memory 120, the system may retrieve these specific nodes without the need to retrieve other nodes.

Reconstructing a particular data object may involve retrieving from disk storage 130 and loading into memory 120 the set of chunk hashes (286a-286d) of data object chunks identified using the above process. After the chunk hashes (286a-286d) are loaded into memory 120, the system may input the hashes into mapping functions that return (generate) the corresponding chunk. The system can reassemble the data object using the generated chunks. For example, the system may arrange the generated chunks in order and concatenate them to generate the data object.

In some implementations, a further technical advantage enabled by the system is optimization of the embedded chunk hash index 274, index 281 and/or index 291. For example, one mode of optimization can include ordering values in the indexes (281, 291) alphabetically, numerically, in a last-in-first-out (LIFO) manner, in a first-in-last-out (FIFO) manner, or in another fashion selected according to the need to optimize updates (e.g., alphabetic or numerical ordering), retrieval (e.g., LIFO ordering) or versioning (e.g., FIFO ordering) of data. Another mode of optimization can include truncating the hash values (chunk hashes, CAS hashes, file hashes) to speed up lookup of values using the indexes (281, 291) such that the size of the indexes (281, 291) is minimized.

### Example Use Cases for Content-Addressed Storage (CAS)

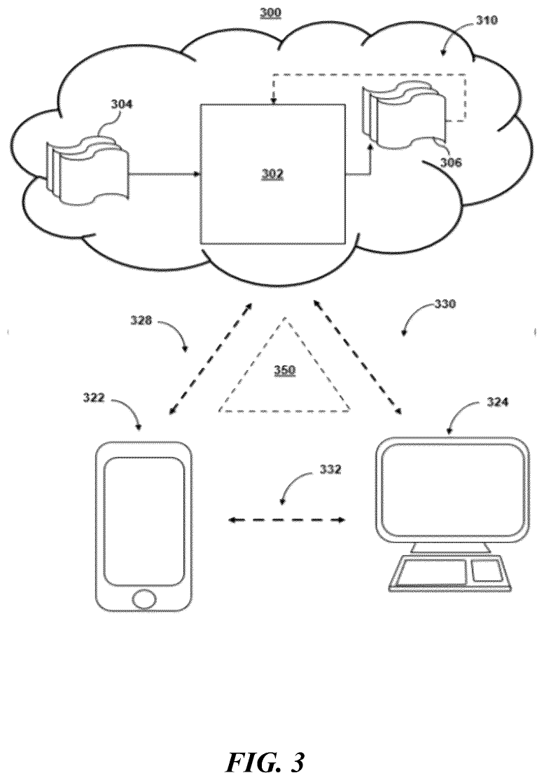

FIG. 3 shows illustrative components for a system 300 that may use content-defined trees to index or deduplicate data (e.g., or perform a variety of other aspects described in connection with FIGS. 1, 2A-2C, and 4-6), in accordance with one or more embodiments. The components shown in system 300 may be used to perform any of the functionality described above in connection with FIG. 1. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, mobile devices, and/or any device or system described in connection with FIGS. 1, 2A-2C, and 4. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., content-defined tree related data, hashes, nodes, etc.).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device, such as a computer screen, and/or a dedicated input device, such as a remote control, mouse, voice input, etc.). Additionally, the devices in system 300 may run an application (or another suitable program). The application may cause the processors and/or control circuitry to perform operations related to using content-defined trees to index or deduplicate data (e.g., or perform a variety of other aspects described in connection with FIGS. 1, 2A-2C, and 4-6),

Each of these devices may also include electronic storages. The electronic storages may include non-transitory storage media that electronically stores information. The electronic storage media of the electronic storages may include one or both of (i) a system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or Long-Term Evolution (LTE) network), a cable network, a public switched telephone network, or other types of communications networks or combinations of communications networks for transmitting electronic messages. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include the CDT system 102 or the user device 104 described in connection with FIG. 1.

Cloud components 310 may include model 302, which may be a machine learning model, artificial intelligence model, etc. (which may be collectively referred to herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may use content-defined trees to index or deduplicate data (e.g., or perform a variety of other aspects described in connection with FIGS. 1, 2A-2C, and 4-6),

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The model (e.g., model 302) may use content-defined trees to index or deduplicate data (e.g., or perform a variety of other aspects described in connection with FIGS. 1, 2A-2C, and 4-6),

System 300 also includes application programming interface (API) layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be a representational state transfer (REST) or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. Simple Object Access Protocol (SOAP) web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols, such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying web application firewall (WAF) and distributed denial-of-service (DDoS) protection, and API layer 350 may use RESTful APIs as standard for external integration.

### Example Methods of Generating Content-Defined Trees

FIG. 4A shows a flowchart of the steps involved in for generating content-defined trees to store data objects, in accordance with one or more embodiments. Although described as being performed by a computing system, one or more actions described in connection with process 400 of FIG. 4A may be performed by one or more devices shown in FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

At step 402, a computing system may obtain a data object. The data object may include a string of bytes. The data object may correspond to a file (e.g., CSV, PDF, SQL, or a variety of other data object types). The data object may be associated with a repository of data. For example, the data object may be one data object in a directory containing other data objects.

At step 404, the computing system may divide the data object into chunks. For example, the computing system may divide the string of bytes into a set of chunks, each chunk in the set of chunks having a boundary, wherein each boundary is determined based on a first rolling hash satisfying a first condition and each boundary defines a size of a corresponding chunk. The first condition may be any condition described above in connection with FIG. 1, 2A-2C, or 3. By doing so, the computing system may be able to use the chunks to generate a content-defined tree and may provide a data object storage solution that is well able to handle insertions or deletions made in the middle of the data object. For example, dividing the data object into chunks in this way may allow for insertions and deletions to be made in the middle of the data object without altering every chunk boundary and may prevent the need for the computing system to recompute every chunk for the data object.

At step 406, the computing system may generate a hash for each chunk that was created in step 404. For example, the computing system may generate a set of hashes including a cryptographic hash for each chunk of the set of chunks. The set of hashes may be used to generate a content-defined tree, for example, as described above in connection with FIG. 1-2A-2C, or 3. The set of hashes may form a first tier (e.g., a bottom tier) of a content-defined tree. Other tiers of the content-defined tree may be generated in steps 408-410 as described below.

At step 408, the computing system may generate a set of parent nodes based on the set of hashes. The computing system may assign each hash of the set of hashes to a group based on a second rolling hash and a second condition. The second condition may be a test on the node hash to target an average branching factor or average group size (e.g., four hashes per group on average). In some embodiments, additional constraints many be used to force the number of hashes per group to be between two and eight inclusive. Each group of hashes may correspond to one parent node in the set of parent nodes. The computing system may concatenate each hash in a group of hashes. The computing system may generate a hash of the concatenated hashes to form the parent node of the group of hashes (e.g., the parent node may be the hash of the concatenated hashes). Each parent node may include a hash that is usable as a key to retrieve each hash in the corresponding group of hashes. For example, a first parent node may include a hash that may key to a data structure that includes each hash of the group of hashes that was used to generate the first parent node. The parent nodes may form a second tier of the content-defined tree.

One technical problem in existing systems is that a small change in the number of chunks (e.g., a chunk insertion at the left, right, middle, etc.), will induce a complete rewrite of a tree built from the chunks. By generating a set of parent nodes using a rolling hash as described here in step 408, the computing system may be resilient against chunks that are added and removed. For example, even if a chunk is added or removed, only a small portion of the parent nodes may be recomputed rather than the entire set of parent nodes.

In some embodiments, a parent node may further include a hash of a MAC. For example, the computing system may generate a hash of a MAC together with a corresponding concatenation of each hash in a group of hashes. For example, both the MAC and group of hashes may be input into the hashing function to generate a single hash. By doing so, the computing system may ensure that for any two different strings (e.g., hashes, groups of hashes, etc.) there are no collisions. This may prevent two different chunks, groups of chunks, or parent nodes from having the same hash.

At step 410, the computing system may generate a root node based on the parent nodes generated at step 408. For example, the computing system may merge each of the parent nodes to form the root node. In one example, the computing system may generate the root node by applying a rolling hash with a condition (e.g., the condition used in step 408) to the set of parent nodes. Based on applying the rolling hash, the computing system may determine that each parent node in the set of parent nodes should be combined into one group. In response, the computing system may concatenate each of the parent nodes (e.g., the hashes of the parent nodes) and generate a hash of the concatenation. The root node may comprise the hash of the concatenation. At step 412, the computing system may store a portion of the content-defined tree (e.g., in the database 106).

In some embodiments, the computing system may generate a content-defined tree that includes multiple data objects or an entire data repository. For example, the data object obtained in step 402 may be part of a set of data objects that is stored in a data repository. The computing system may generate, based on the data repository, a metadata store comprising a directory layout and metadata of the data repository. The computing system may generate a byte stream comprising a concatenation of all bytes of all data objects in the data repository. The concatenation may be sorted in hash order. The computing system may generate a second content-defined tree based on the byte stream. In some embodiments, the computing system may insert a chunk boundary at an end of each data object in the data repository. This may cause a new chunk to be created for the beginning of every data object or data object in the repository.

In some embodiments, the data repository may correspond to a dataset for training a machine learning model. The computing system may use the content-defined tree to split the data repository into train, test, validation, or other sets to use in training the machine learning model. The computing system may designate a first portion of the set of parent nodes as a training dataset and a second portion of the set of parent nodes as a testing dataset; and training the machine learning model using the training dataset and the testing dataset.

In some embodiments, the computing system may use the content-defined tree to compare data objects to determine a difference between the data objects. For example, the computing system may determine, based on a comparison of the content-defined tree with a second content-defined tree, that the data object has been modified. Based on the modification to the data object, the computing system may update a hash of a parent node of the set of parent nodes to include the modification. For example, one or more new chunks may be generated for the data object because of the modification made to the data object. A new hash may be created for a new chunk that is created and may be inserted into the content-defined tree. Any parent nodes of the new hash may be generated based on the changes.

### Example Methods of Generating Scalable Data Structures for Content-Defined Trees

FIG. 4B shows a flowchart of steps involved in generating a scalable data structure for binary file deduplication, in accordance with one or more embodiments. Although described as being performed by a computing system, one or more actions described in connection with FIG. 4B may be performed by one or more devices shown in FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

At step 420, a set of nodes may be generated by a computing system. The set of nodes can store information for a particular data object, such as a file on a file system of a computing system. The set of nodes may include, for example, hashes of various chunks of a particular data object, where the chunks can be determined using a suitable technique, such as a rolling window technique. In some embodiments, the set of nodes is a multilevel (nested) set of nodes. The set of nodes make a content-defined tree. The content-defined tree may include any aspect described above (e.g., in connection with FIG. 1-2D).

At step 422, the computing system may generate a node information structure to link hashes of chunks from data objects to nodes in a CAS tree. In some embodiments, the node information structure includes elements of the example node-to-storage linking structure described in relation to FIG. 2D. The structure can be implemented as a linked list, collection of key-value pairs, set of tables in one or more relational databases, or as another suitable data structure. The generated structure may include or be associated with header information, CAS node information, and/or file information as described in relation to FIG. 2D. The generated structure may be populated with the nodes generated at step 420 and stored relationally to a supernode (e.g., a root node, a parent node, and so forth). The generated structure can also include or be associated with a node index, such as the index chunk-to-location lookup index 281.

At step 424, the computing system may generate a set of on-disk storage hashes, such as the file hashes described in relation to FIG. 2D and/or, more generally, file identifiers. In an example, the set can include at least one hash of a file identifier for a unit (e.g., file) that stores the data object in the file system. The on-disk storage hashes may be sufficient to locate the corresponding data object in the file system. For example, the on-disk storage hashes may include a file path or the like.

At step 426, the computing system may generate an on-disk storage information structure, such as the file information 290 described in relation to FIG. 2D. The on-disk storage information structure may include various items, such as the on-disk storage hashes (file hashes), shard identifiers, metadata, CAS node information, byte ranges, and so forth. The on-disk storage information structure may associate a particular file (object data) with its corresponding CAS nodes.

At step 428, the system can associate the node information structure with the on-disk storage information structure. This may be done, for example, by generating and/or updating an index structure, such as storage-to-shard lookup index, which facilitates reconstruction of data. The storage-to-shard lookup index may store a set of relations (e.g., in the form of key-value pairs, delimited data records, and so forth) between shard identifiers and their corresponding file hashes.

In some implementations, the items generated at steps 420-422 are generated in memory 120 and are retrievably stored in disk storage 130. Accordingly, the CAS tree represented by the items can be moved to disk, which improves scalability of CAS implementations.

### Example Methods of Deduplicating Content Using the Scalable Data Structures

FIG. 4C shows a flowchart of steps involved in deduplicating (e.g., in response to an “insert” operation request) new content using a previously generated scalable data structure for binary file deduplication, in accordance with one or more embodiments. Although described as being performed by a computing system, one or more actions described in connection with FIG. 4C may be performed by one or more devices shown in FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

At step 442, the system may receive (e.g., from a requestor computing system, such as a system described in relation to FIG. 3), a hash value for a particular chunk of a data object. The chunk of the data object may have been previously parsed out of the data object using the rolling window technique or another suitable technique.

After the system receives the chunk, the system may execute operations to determine whether the chunk was previously stored (e.g., for a previous version of the data object) or whether the chunk needs to be newly stored (e.g., for a latest version of the data object, where the chunk represents new data relative to the previous version). In order to make this determination, the system may, at step 444, search an index (e.g., the chunk-to-location lookup index 281) to determine, at decisional 446, if a hash value for the chunk exists in the index (for example, by comparing the hash value to previously stored hash values). These operations can be performed in memory 120, which, advantageously, does not require the corresponding values, or even scalable data structures that hold pointers to the hashed values, to be retrieved from disk storage 130 and loaded into memory 120.

If it is determined that the hash was previously stored, then, at step 448, the system may perform suitable operations. For example, if the request is merely an update request, the system may forgo saving the received hash value, thus avoiding data duplication. If the request is also a retrieval request, the system may locate and reconstruct the chunk by, for example, referencing the CAS node information 280 where the hash was found.

If it is determined that the hash was not previously stored, then, at step 450, the system may store the chunk that corresponds to the received hash. For example, the system may generate a new CAS hash that includes the received hash (in some embodiments, in combination with other hashes). The system may, at step 452, update the linking structure to include the new CAS hash. For example, the system may add an entry to the index 281. The entry can include the new CAS hash and the corresponding chunk hash, rolling window information, etc. The system may also add an entry to the index 291. For example, the system may update an entry for a particular file identifier with information (metadata, byte range) for the new CAS node. In some embodiments, the system may generate a new file identifier that represents an up-to-date collection of CAS nodes for a data object, including the new CAS node.

### Example Methods of Content Retrieval Using the Scalable Data Structures

FIG. 5 shows a flowchart of steps involved in retrieving chunks for reconstructing a data object using a previously generated scalable data structure for binary file deduplication, in accordance with one or more embodiments. FIG. 5 shows a flowchart of the steps involved in for generating content-defined trees to store data objects, in accordance with one or more embodiments. Although described as being performed by a computing system, one or more actions described in connection with process 500 of FIG. 5 may be performed by one or more devices shown in FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

At step 502, the system may obtain a request for a data object (file) or for a portion of data. The request may be sent by a user device (requestor computing system). For example, the user device may send a request with an identification of the data object to the computing system. The request may include a data object identifier. In some embodiments, the data object identifier is a plain-text identifier (e.g., file name, path, and so forth), and the system may generate a hash of the identifier. In some embodiments, the request for the data object already includes a file hash. In some embodiments, the request includes a set of chunk hashes for the chunks in the file that are requested.

In some embodiments, the request includes information sufficient for the system to generate or determine the requested chunk hashes. For example, in some embodiments, a single file may correspond to a single shard, and a particular node-to-storage linking structure 270 may correspond to the shard, therefore representing the file. In such instances, at steps 504-506, the system may search the embedded chunk hash index 274 for the linking structure 270 in order to determine the needed chunks.

In other instances, the system may, at step 504, locate the node-to-storage linking structure (shard) where the data object or a portion thereof is stored, by using the received data object identifier. For example, the system may search the index 291 to identify the shard identifier and the corresponding CAS nodes. At step 506, the platform may retrieve the chunk hashes that correspond to the identified CAS nodes.

At step 508, the system may retrieve the set of data object chunks and reconstruct the file. For example, the system may input a chunk hash into a mapping function that returns the corresponding chunk. The system may, further, reconstruct or reassemble the data object using the retrieved data object chunks. For example, the computing system may arrange the chunks in order and concatenate them to generate the data object. The order can be indicated, for example, by the byte ranges of the CAS nodes that correspond to the chunk hashes. Collectively, intersections of the byte ranges, according to the rolling window or other criteria, can define the larger byte range to be retrieved.

It is contemplated that the steps or descriptions of FIGS. 4A-5 may be used with any other embodiment of this disclosure in any suitable combination. In addition, the steps and descriptions described in relation to FIGS. 4A-5 may be done in alternative orders or in parallel to further the purposes of this disclosure. For example, each of these steps may be performed in any order, in parallel, or simultaneously to reduce lag or to increase the speed of the system or method. Furthermore, it should be noted that any of the components, devices, or equipment discussed in relation to the figures above could be used to perform one or more of the steps in FIGS. 4A-5.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A computing system for deduplicating a content addressed storage (CAS) tree to facilitate storage and retrieval of a data object on the computing system by moving aspects of the CAS tree from memory to disk, the system comprising:
one or more processors; and
one or more non-transitory, computer readable media having instructions stored thereon that, when executed by the one or more processors, cause the computing system to perform operations comprising:
generating a CAS node of the CAS tree, the CAS node comprising a first copy of a first hash that corresponds to a first chunk of a data object and a first copy of a second hash that corresponds to a second chunk of the data object;
generating a CAS node index, wherein the CAS node index is structured to associate the CAS node with the first copy of the first hash and the first copy of the second hash;
using the generated CAS node, generating an on-disk storage identifier that corresponds to the generated CAS node and a byte range within the data object, wherein the on-disk storage identifier is sufficient to identify the data object in a file system of the computing system;
retrievably storing, on disk-based storage, the generated CAS node in association with the CAS node index and the on-disk storage identifier.

2. The computing system of claim 1, wherein the instructions, when executed by the one or more processors, cause operations further comprising:
receiving a second copy of the first hash and a first copy of a third hash that corresponds to a third chunk of the data object;
based on a determination that the CAS node index includes the first copy of the first hash that corresponds to the second copy of the first hash, forgoing operations to save the second copy of the first hash to the disk-based storage; and
based on a determination that the CAS node index does not include the third hash, performing operations comprising:
generating a second CAS node comprising the first copy of the third hash;
updating the CAS node index to add an association between the generated second CAS node and the first copy of the third hash;
using the generated second CAS node, updating the on-disk storage identifier to add an indication of a link between the generated second CAS node and a second byte range within the data object, wherein the second byte range corresponds to the third chunk; and
retrievably storing, on the disk-based storage, the generated second CAS node in association with the CAS node index and the on-disk storage identifier.

3. The computing system of claim 2, wherein the instructions, when executed by the one or more processors, cause operations further comprising:
receiving, from a requestor computing system, a request for a data object, the request comprising a data object identifier;
based on a determination that the data object identifier matches the on-disk storage identifier, performing operations comprising:
retrieving, from the disk-based storage and using the data object identifier, a first identifier of the first CAS node and a second identifier of the second CAS node;
cross-referencing the first identifier of the first CAS node to the CAS node index to identify the first hash and the second hash;
cross-referencing the second identifier of the second CAS node to the CAS node index to identify the third hash;
reconstructing the data object using the first hash, the second hash, and the third hash; and
generating and transmitting, to the requestor computing system, an electronic message comprising the reconstructed data object.

4. The computing system of claim 3, wherein reconstructing the data object comprises:
causing a copy of the first chunk to be generated by executing a mapping function using the first hash as an input;
causing a copy of the second chunk to be generated by executing the mapping function using the second hash as an input; and
concatenating the generated copy of the first chunk with a generated copy of the second chunk.

5. A method for deduplicating a content addressed storage (CAS) tree to facilitate storage and retrieval of a data object on a computing system by moving aspects of the CAS tree from memory to disk, the method comprising:
generating a CAS node of the CAS tree, the CAS node comprising a first copy of a first hash that corresponds to a first chunk of a data object and a first copy of a second hash that corresponds to a second chunk of the data object;
generating a CAS node index, wherein the CAS node index is structured to associate the CAS node with the first copy of the first hash and the first copy of the second hash;
using the generated CAS node, generating an on-disk storage identifier that corresponds to the generated CAS node and a byte range within the data object, wherein the on-disk storage identifier is sufficient to identify the data object in a file system of the computing system;
retrievably storing, on disk-based storage, the generated CAS node in association with the CAS node index and the on-disk storage identifier.

6. The method of claim 5, wherein the on-disk storage identifier is stored relationally to a hash of the generated CAS node and a byte range, the method further comprising:
determining the byte range within the data object by determining an intersection of a first byte range for the first chunk and a second byte range for the second chunk.

7. The method of claim 5, wherein the CAS node is a first CAS node and the byte range is a first byte range, the method further comprising:
receiving a second copy of the first hash and a first copy of a third hash that corresponds to a third chunk of the data object;
based on a determination that the CAS node index includes the first copy of the first hash that corresponds to the second copy of the first hash, forgoing operations to save the second copy of the first hash to the disk-based storage; and
based on a determination that the CAS node index does not include the third hash, performing operations comprising:
generating a second CAS node comprising the first copy of the third hash;
updating the CAS node index to add an association between the generated second CAS node and the first copy of the third hash;
using the generated second CAS node, updating the on-disk storage identifier to add an indication of a link between the generated second CAS node and a second byte range within the data object, wherein the second byte range corresponds to the third chunk; and
retrievably storing, on the disk-based storage, the generated second CAS node in association with the CAS node index and the on-disk storage identifier.

8. The method of claim 7, further comprising:
receiving, from a requestor computing system, a request for a data object, the request comprising a data object identifier;
based on a determination that the data object identifier matches the on-disk storage identifier, performing operations comprising:
retrieving, from the disk-based storage and using the data object identifier, a first identifier of the first CAS node and a second identifier of the second CAS node;
cross-referencing the first identifier of the first CAS node to the CAS node index to identify the first hash and the second hash;
cross-referencing the second identifier of the second CAS node to the CAS node index to identify the third hash;
reconstructing the data object using the first hash, the second hash, and the third hash; and
generating and transmitting, to the requestor computing system, an electronic message comprising the reconstructed data object.

9. The method of claim 8, wherein reconstructing the data object comprises causing a copy of the first chunk to be generated by executing a mapping function using the first hash as an input.

10. The method of claim 9, further comprising:
causing a copy of the second chunk to be generated; and
concatenating the generated copy of the first chunk with a generated copy of the second chunk.

11. The method of claim 5, further comprising:
segmenting the data object into the first chunk and the second chunk according to a rolling hash window;
generating the first hash by executing a hashing function in relation to the first chunk; and
generating the second hash by executing the hashing function in relation to the second chunk.

12. The method of claim 5, wherein the on-disk storage identifier is stored relationally to a shard identifier that corresponds to a subset of nodes from the CAS tree.

13. One or more non-transitory, computer-readable media comprising instructions that when executed by one or more processors, cause a computing system to perform operations for deduplicating a content addressed storage (CAS) tree to facilitate storage and retrieval of a data object on a computing system by moving aspects of the CAS tree from memory to disk, the operations comprising:
generating a CAS node of the CAS tree, the CAS node comprising a first copy of a first hash that corresponds to a first chunk of a data object and a first copy of a second hash that corresponds to a second chunk of the data object;
generating a CAS node index, wherein the CAS node index is structured to associate the CAS node with the first copy of the first hash and the first copy of the second hash;
using the generated CAS node, generating an on-disk storage identifier that corresponds to the generated CAS node and a byte range within the data object, wherein the on-disk storage identifier is sufficient to identify the data object in a file system of the computing system;
retrievably storing, on disk-based storage, the generated CAS node in association with the CAS node index and the on-disk storage identifier.

14. The media of claim 13, wherein the on-disk storage identifier is stored relationally to a hash of the generated CAS node and a byte range, the operations further comprising:
determining the byte range within the data object by determining an intersection of a first byte range for the first chunk and a second byte range for the second chunk.

15. The media of claim 13, wherein the CAS node is a first CAS node and the byte range is a first byte range, the operations further comprising:
receiving a second copy of the first hash and a first copy of a third hash that corresponds to a third chunk of the data object;
based on a determination that the CAS node index includes the first copy of the first hash that corresponds to the second copy of the first hash, forgoing operations to save the second copy of the first hash to the disk-based storage; and
based on a determination that the CAS node index does not include the third hash, performing operations comprising:
generating a second CAS node comprising the first copy of the third hash;
updating the CAS node index to add an association between the generated second CAS node and the first copy of the third hash;
using the generated second CAS node, updating the on-disk storage identifier to add an indication of a link between the generated second CAS node and a second byte range within the data object, wherein the second byte range corresponds to the third chunk; and
retrievably storing, on the disk-based storage, the generated second CAS node in association with the CAS node index and the on-disk storage identifier.

16. The media of claim 15, the operations further comprising:
receiving, from a requestor computing system, a request for a data object, the request comprising a data object identifier;
based on a determination that the data object identifier matches the on-disk storage identifier, performing operations comprising:
retrieving, from the disk-based storage and using the data object identifier, a first identifier of the first CAS node and a second identifier of the second CAS node;
cross-referencing the first identifier of the first CAS node to the CAS node index to identify the first hash and the second hash;
cross-referencing the second identifier of the second CAS node to the CAS node index to identify the third hash;
reconstructing the data object using the first hash, the second hash, and the third hash; and
generating and transmitting, to the requestor computing system, an electronic message comprising the reconstructed data object.

17. The media of claim 16, wherein reconstructing the data object comprises causing a copy of the first chunk to be generated by executing a mapping function using the first hash as an input.

18. The media of claim 17, the operations further comprising:
causing a copy of the second chunk to be generated; and
concatenating the generated copy of the first chunk with a generated copy of the second chunk.

19. The media of claim 13, the operations further comprising:
segmenting the data object into the first chunk and the second chunk according to a rolling hash window;
generating the first hash by executing a hashing function in relation to the first chunk; and
generating the second hash by executing the hashing function in relation to the second chunk.

20. The media of claim 13, wherein the on-disk storage identifier is stored relationally to a shard identifier that corresponds to a subset of nodes from the CAS tree.
